(19) United States
(12) Patent Application Publication
(10) Pub. No.: US 2010/0322052 A1
(43) Pub. Date: Dec. 23, 2010

(54) REPRODUCTION SIGNAL QUALITY EVALUATION DEVICE AND METHOD

(75) Inventor: Takeshi NAKAJIMA, Nara (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/869,391

(22) Filed: Aug. 26, 2010

Related U.S. Application Data
(63) Continuation of application No. PCT/JP2009/000481, filed on Feb. 6, 2009.

(30) Foreign Application Priority Data
Mar. 31, 2008 (JP) 2008-093347

(51) Int. Cl. G11B 27/36

(52) U.S. Cl. 369/53.31; G9B/27.052

(57) ABSTRACT

In a reproduction signal quality evaluation device, a pattern detector detects, from a code sequence obtained by PRML decoding, a predetermined pattern including a portion corresponding to a zero-cross point of a reproduction signal sequence obtained by PR equalization in PRML decoding. A distance difference calculator calculates a difference between the distances between the reproduction signal sequence and each of two ideal transition sequences of the reproduction signal sequence by computing an expression corresponding to the detected pattern using the value of a sample point of the reproduction signal sequence that is in a portion corresponding to the detected pattern and corresponds to a code relatively greatly weighted in an equalization expected value of a code sequence subsequent to the detected pattern. A dispersion calculator calculates a dispersion of the calculated distance difference.

### CROSS-REFERENCE TO RELATED APPLICATION

This is a continuation of PCT International Application PCT/JP2009/000481 filed on Feb. 6, 2009, which claims priority to Japanese Patent Application No. 2008-093347 filed on Mar. 31, 2008. The disclosures of these applications including the specifications, the drawings, and the claims are hereby incorporated by reference in their entirety.

### BACKGROUND

The present disclosure relates to a device and method for evaluating the quality of a signal read from an optical disc and maximum-likelihood decoded.

In optical disc units adapted to high-density recording such as next-generation DVD units, intersymbol interference in a reproduction signal increases, and moreover the SN ratio decreases. Therefore, to improve the device reliability, partial response maximum likelihood (PRML) decoding that is widely used in hard disk drives is adopted also in optical disc units.

In PRML decoding, a recorded code sequence is decoded by selecting a most likely state transition sequence. More specifically, a reproduction signal is sampled in synchronization with a reproduction clock, and maximum-likelihood decoding is performed based on the Euclidean distance between the reproduction signal sequence and each equalization expected value of the code sequence. Therefore, in PRML decoding, unlike the conventional method of performing bit-by-bit determination using a comparator, the entire of the sampled reproduction signal, not only a portion near a position where comparator-detected pulses change, affects the decoded results. For example, for the same jitter value of the reproduction signal, a PRML decoding error occurs in some cases, but does not occur in other cases. It is therefore difficult to predict the error rate of an optical disc unit adopting PRML decoding using the jitter of the reproduction signal as an indicator. Thus, a method of measuring the error rate suitable for PRML decoding is required.

There is conventionally a technique in which a combination of state transitions that can assume two paths most likely to cause an error in PRML decoding (i.e., two paths between which the Euclidean distance is minimum) is selected, and based on the absolute value of the difference in likelihood between such paths, the quality of an optical disc reproduction signal is evaluated.

### SUMMARY OF THE INVENTION

In recent years, the speed of optical disc units is increasing: data can be read at a speed of 52× or higher for CDs and 16× or higher for DVDs. In the future, demands for higher recording/reproduction speed are expected to rise also for next-generation DVD units. However, the conventional reproduction signal evaluation device has its limit in allowing a circuit of determining the Euclidean distance every maximum-likelihood decoded result to operate at high speed and with low power consumption.

Also, it is presumed that a future optical disc unit performing further high-density recording/reproduction will adopt high-order PR equalization that allows more increase in intersymbol interference. In such a case, it is necessary to detect more patterns from a code sequence obtained by decoding and calculate an accumulated value for each of the patterns. However, the device also has its limit in performing this processing at high speed and with low power consumption. Moreover, in optical discs meant for high-density recording, the error rate may predominantly be affected by waveform distortion in some cases. Therefore, correct quality evaluation is also necessary for a reproduction signal having waveform distortion.

An example reproduction signal quality evaluation device or method for evaluating the quality of a reproduction signal from an optical disc of an embodiment of the present invention includes: a pattern detector configured to detect, or a step of detecting, from a code sequence obtained by PRML decoding, a predetermined pattern including a portion corresponding to a zero-cross point of a reproduction signal sequence obtained by PR equalization in PRML decoding; a distance difference calculator configured to calculate, or a step of calculating, a difference between distances between the reproduction signal sequence and each of two ideal transition sequences of the reproduction signal sequence by computing an expression corresponding to the detected pattern using a value of a sample point of the reproduction signal sequence that is in a portion corresponding to the detected pattern and corresponds to a code relatively greatly weighted in an equalization expected value of a code sequence subsequent to the detected pattern; and a dispersion calculator configured to calculate, or a step of calculating, a dispersion of the calculated distance difference.

With the above configuration or method, the difference between the distances between the reproduction signal sequence and each of two ideal transition sequences is calculated for only a sample point predominant in an equalization expected value of the code sequence subsequent to the detected pattern. Therefore, while the precision of the calculated distance difference is kept comparatively high, the calculation amount for the calculation concerned can be reduced compared with the conventional case.

Preferably, the two ideal transition sequences are paths that can be selected in PRML decoding. This further reduces the objects to be computed in the calculation of the distance difference, and thus the calculation amount can be further reduced.

### BRIEF DESCRIPTION OF THE DRAWINGS

FIG. 1 is a view showing a configuration of an optical disc unit including a reproduction signal quality evaluation device of an embodiment of the present invention.

FIG. 2 is a view showing a configuration of a reproduction signal quality evaluation device of the first embodiment.

FIG. 3 shows views each having two paths crossing a zero-cross level in PR (1,2,2,1) equalization.

FIG. 4 is a view showing a configuration of a reproduction signal quality evaluation device of the second embodiment.

FIG. 5 is a view showing a configuration of a reproduction signal quality evaluation device of the third embodiment.

FIG. 6 shows views each having two paths crossing a zero-cross level in PR (1,2,2,2,1) equalization.

### DESCRIPTION OF EMBODIMENTS

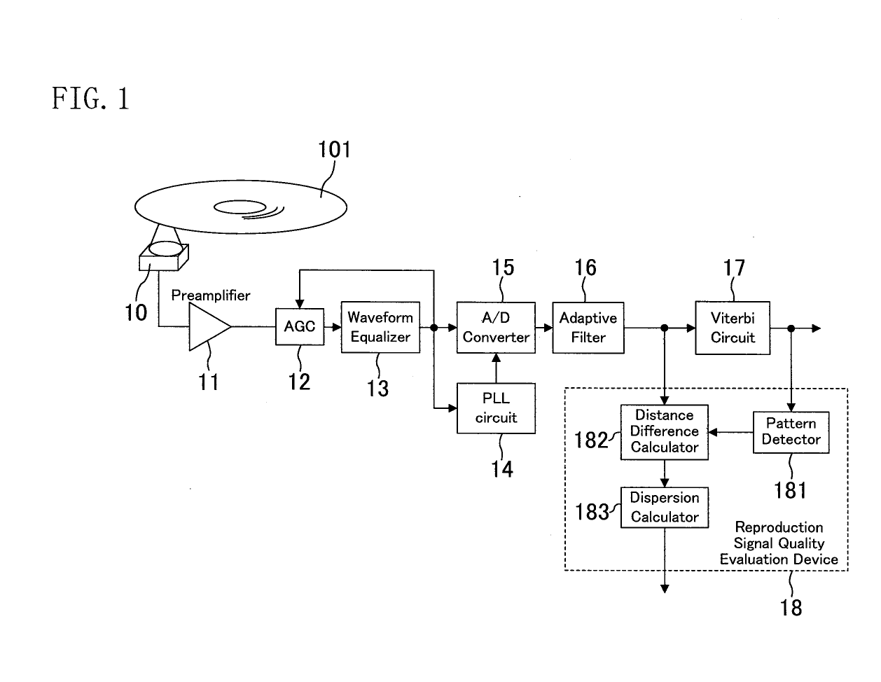

Best modes for carrying out the present invention will be described hereinafter with reference to the accompanying drawings. FIG. 1 shows a configuration of an optical disc unit including a reproduction signal quality evaluation device of an embodiment of the present invention. In the optical disc unit 100, a reproduction signal read from an optical disc 101 by an optical head 10 is amplified and AC-coupled by a preamplifier 11, and then input into an AGC 12. In the AGC 12, the gain is adjusted so that the output of a waveform equalizer 13 at the subsequent stage has constant amplitude. The reproduction signal output from the AGC 12 is subjected to waveform shaping by the waveform equalizer 13, and the waveform-shaped reproduction signal is input into a PLL circuit 14 and an A/D converter 15. The PLL circuit 14 extracts a reproduction clock from the reproduction signal. The A/D converter 15 samples the reproduction signal using the reproduction clock output from the PLL circuit 14. The sampled value is input into an adaptive filter 16, which corrects the frequency characteristic of the input signal with a predetermined PR equalization characteristic. A Viterbi circuit 17 performs maximum-likelihood decoding for the reproduction signal sequence output from the adaptive filter 16, to generate binarized data, or a code sequence.

The reproduction signal quality evaluation device 18 evaluates the quality of the reproduction signal from the optical disc 101. In the reproduction signal quality evaluation device 18, a pattern detector 181 detects, from the code sequence output from the Viterbi circuit 17, a predetermined pattern including a portion corresponding to a zero-cross point of the reproduction signal sequence. The zero-cross point refers to a point at which the output of a comparator changes in binarization of the reproduction signal sequence using the comparator.

A distance difference calculator 182 computes an expression corresponding to the detected pattern using the value of a sample point of the reproduction signal sequence output from the adaptive filter 16 that is in a portion corresponding to the detected pattern and corresponds to a code relatively greatly weighted in an equalization expected value of a code sequence subsequent to the detected pattern. By this computation, the distance difference calculator 182 calculates the distance difference between the distances between the reproduction signal sequence and each of two ideal transition sequences of the reproduction signal sequence. Assuming that the two ideal transition sequences are path A and path B, the distance difference refers to the difference between the accumulated value Pa of the difference between the value of each sample point and each equalization expected value related to path A and the accumulated value Pb of the difference between the value of each sample point and each equalization expected value related to path B (|Pa−Pb|). Note that, to synchronize the timing of the pattern detection by the pattern detector 181 with the timing of input of the reproduction signal sequence into the distance difference calculator 182, the reproduction signal sequence output from the adaptive filter 16 is delayed by a delay circuit not shown before being input into the distance difference calculator 182.

More specifically, the distance difference calculator 182 may compute all expressions for the input reproduction signal sequence in advance in synchronization with the adaptive filter 16, the Viterbi circuit 17, and the like, and, once a predetermined pattern is detected by the pattern detector 181, output the result of an expression corresponding to the predetermined pattern.

A dispersion calculator 183 calculates a dispersion of the distance difference |Pa−Pb| output from the distance difference calculator 182. More specifically, the dispersion calculator 183 calculates at least the standard deviation a of the distance difference |Pa−Pb|, and further calculates the average value Pave of the distance difference |Pa−Pb|, as required. The error rate of the reproduction signal can be determined from these values. For example, an error rate P (σ, Pave) represented by the following equation where dₘᵢₙ is the minimum distance between two paths can be used as an indicator for evaluation of the quality of the reproduction signal.

$$P ( σ , Pave ) = erfc ( \frac{{d}_{min} + Pave}{σ} ) \\ where , erfc ( z ) = \frac{1}{\sqrt{2 π}} {\int }_{z}^{∞} exp ( - \frac{{u}^{2}}{2} ) d u \qquad [ Equation 1 ]$$

Also, assuming that the average value Pave is “0,” the maximum likelihood sequence error (MLSE) defined by the following equation can be used as an indicator for evaluation of the quality of the reproduction signal.

$$MLSE = \frac{σ}{2 \cdot {d}_{min}^{2}} [ \% ] \qquad [ Equation 2 ]$$

Next, some examples of the configuration of the reproduction signal quality evaluation device 18 and operations thereof will be described. In the following description, it is assumed that RLL (1,7) codes having a minimum polarity inversion interval of 2 are recorded on the optical disc 101.

### First Embodiment

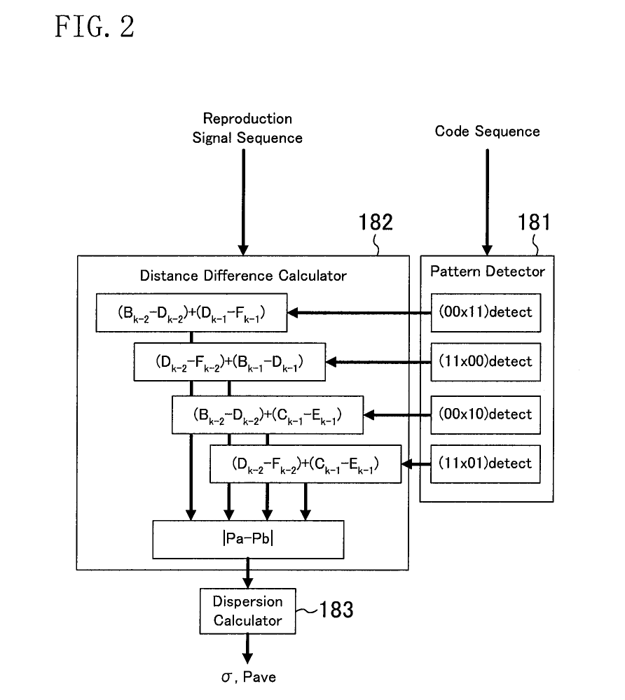

FIG. 2 shows a configuration of the reproduction signal quality evaluation device 18 of the first embodiment. Assume that a reproduction signal sequence subjected to PR (1,2,2,1) equalization is input into the distance difference calculator 182. In PR (1,2,2,1) equalization, the equalization expected value of the code sequence takes any of seven values from 0 to 6. In this embodiment, the equalization expected value “3” corresponds to the zero-cross level. The pattern detector 181 detects four 5-bit patterns, (00x11), (11x00), (00x10), and (11x01), where x is any given 1-bit value, from the input code sequence as predetermined patterns each including a portion corresponding to a zero-cross point of the reproduction signal sequence. When the reproduction signal sequence is subjected to PR (1,2,2,1) equalization, the fourth-bit and fifth-bit codes of each pattern are weighted with “2” in the equalization expected value of a code sequence subsequent to the detected pattern. In other words, these two codes are codes predominant in the equalization expected value of the code sequence subsequent to the detected pattern. Accordingly, the distance difference calculator 182 calculates the distance difference from the values yₖ₋₂ and yₖ₋₁ of the two sample points of the reproduction signal sequence corresponding to the fourth-bit and fifth-bit codes of each pattern.

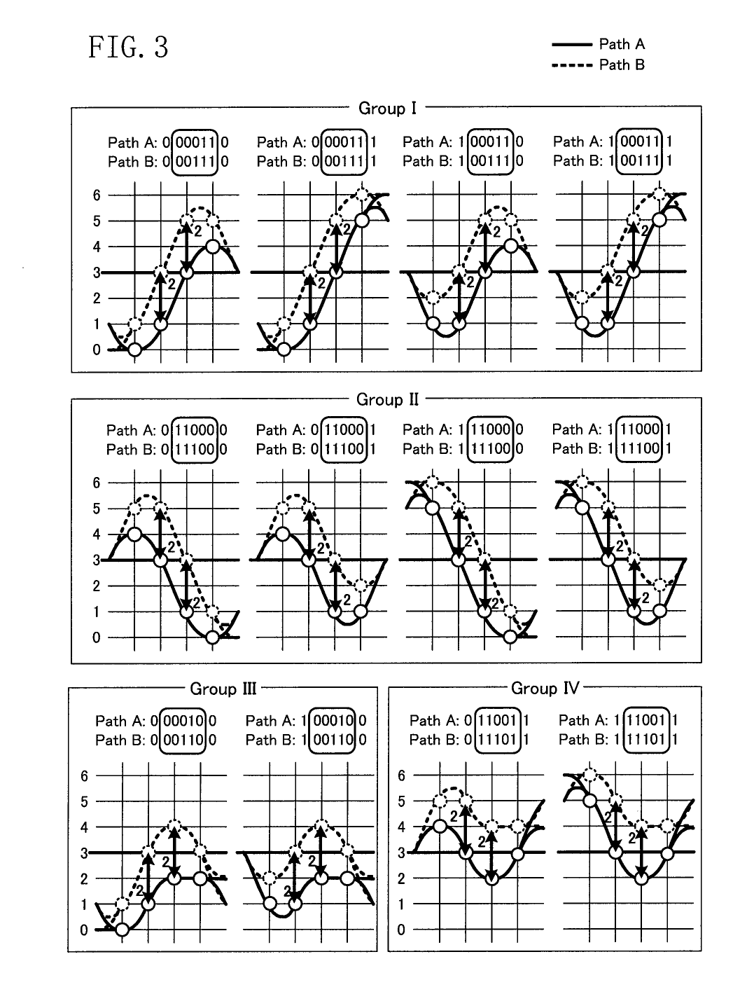

FIG. 3 shows views each having two paths (a path pair) crossing a zero-cross level in PR (1,2,2,1) equalization. Four path pairs belonging to Group I correspond to the pattern (00x11). When the pattern (00x11) is detected, the equalization expected value for the two sample points shifts from “1” to “3” (path A) or from “3” to “5” (path B). Four path pairs belonging to Group II correspond to the pattern (11x00). When the pattern (11x00) is detected, the equalization expected value for the two sample points shifts from “3” to “1” (path A) or from “5” to “3” (path B). Two path pairs belonging to Group III correspond to the pattern (00x10). When the pattern (00x10) is detected, the equalization expected value for the two sample points shifts from “1” to “2” (path A) or from “3” to “4” (path B). Two path pairs belonging to Group IV correspond to the pattern (11x01). When the pattern (11x01) is detected, the equalization expected value for the two sample points shifts from “3” to “2” (path A) or from “5” to “4” (path B). Any path pair belonging to any group has a mutual distance dₘᵢₙ of √(2²+2²).

Referring back to FIG. 2, the distance difference calculator 182 computes an expression corresponding to the pattern detected by the patter detector 181 using the values of two sample points, to calculate the difference |Pa−Pb| between the distances between the reproduction signal sequence and each of two ideal transition sequences. The correspondences between the detected patterns and the computation expressions are as follows:

(1) For pattern (00x11),(Bₖ₋₂−Dₖ₋₂)+(Dₖ₋₁−Fₖ₋₁) Expression I

(2) For pattern (11x00),(Dₖ₋₂−Fₖ₋₂)+(Bₖ₋₁−Dₖ₋₁) Expression II

(3) For pattern (00x10),(Bₖ₋₂−Dₖ₋₂)+(Cₖ₋₁−Eₖ₋₁) Expression III

(4) For pattern (11x01), (Dₖ₋₂−Fₖ₋₂)+(Cₖ₋₁−Eₖ₋₁) Expression IV

where, Bⱼ=(yⱼ−1)², Cⱼ=(yⱼ−2)², Dⱼ=(yⱼ−3)², Eⱼ=(yⱼ−4)², and Fⱼ=(yⱼ−5)². For example, assuming that a pattern (11100) is detected and the values of two sample points of the reproduction signal sequence are “4.7” and “2.7,” the distance difference calculator 182 computes Expression II using these values as follows, to obtain “5.6” as the distance difference |Pa−Pb|.

Pa−Pb=(4.7−3.0)²−(4.7−5.0)²+(2.7−1.0)²−(2.7−3.0)²=5.6

As described above, in this embodiment, in the optical disc unit adopting PR(1,2,2,1) equalization, the quality of the signal reproduced from the optical disc can be evaluated with a calculation amount smaller than that conventionally required. The calculation amount can be further reduced by using only one sample point. A similar effect can also be obtained by generalizing the PR equalization into PR (a,b,b,a) equalization where a and b are positive integers.

### Second Embodiment

The path A in Group III and the path B in Group IV are paths that are never selected in PRML decoding performed for RLL (1,7) codes having a minimum polarity inversion interval of 2. In other words, the path B in Group III and the path A in Group IV are always selected. In the first embodiment, by considering paths that are never selected in PRML decoding as virtual paths having a 1-bit error, patterns (00110) and (11001) representing repetition of shortest pits or shortest marks formed on the recording surface of the optical disc 101 can be detected, which detection is unattainable in Group I or Group II. In this way, the quality of the reproduction signal can be evaluated for all zero-cross points of the reproduction signal sequence. However, for calculation of the difference in likelihood between two paths most likely to have an error in PRML decoding, it is unnecessary to consider such virtual paths. That is, no problem will occur by excluding the paths belonging to Group III and Group IV from the objects to be computed by the distance difference calculator 182.

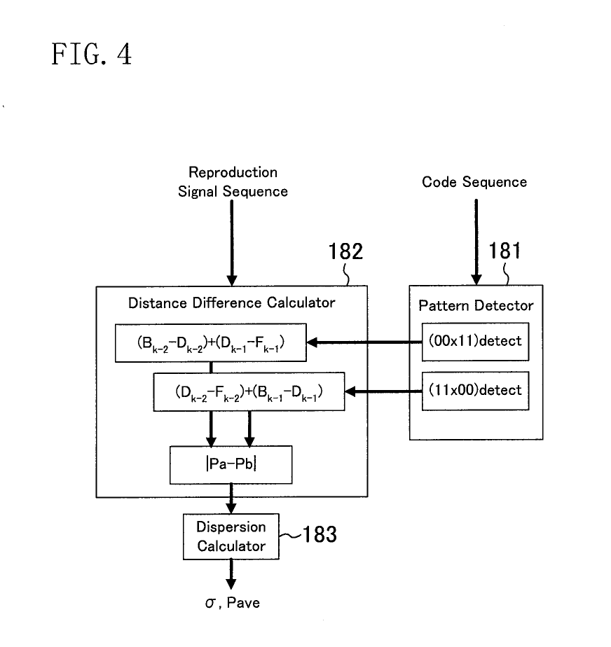

FIG. 4 shows a configuration of the reproduction signal quality evaluation device 18 of the second embodiment. The pattern detector 181 detects only two 5-bit patterns (00x11) and (11x00) of Group I and Group II shown in FIG. 3 from the input code sequence. The distance difference calculator 182 calculates the distance difference |Pa−Pb| by selecting either one of Expression I and Expression II according to the pattern detected by the pattern detector 181. Thus, in this embodiment, the quality of the optical disc reproduction signal can be evaluated with a calculation amount smaller than that in the first embodiment.

### Third Embodiment

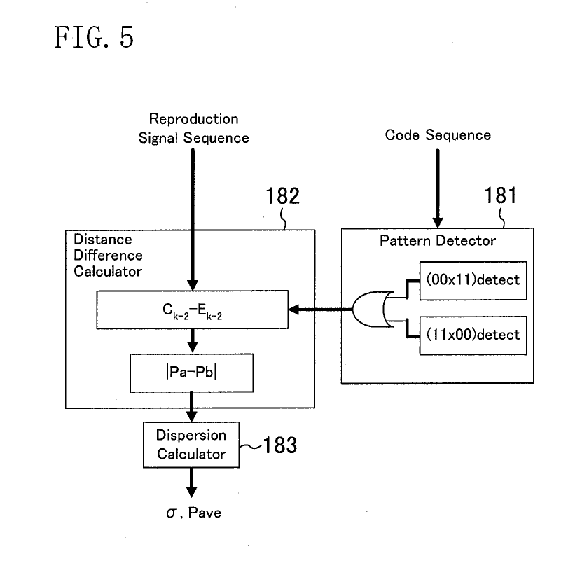

FIG. 5 shows a configuration of the reproduction signal quality evaluation device 18 of the third embodiment. Assume in this embodiment that a reproduction signal sequence subjected to PR (1,2,2,2,1) equalization is input into the distance difference calculator 182. In PR (1,2,2,2,1) equalization, the equalization expected value of the code sequence takes any of nine values from 0 to 8. In this embodiment, the equalization expected value “4” corresponds to the zero-cross level. The pattern detector 181 detects two 5-bit patterns, (00x11) and (11x00), from the input code sequence as predetermined patterns including a portion corresponding to a zero-cross point of the reproduction signal sequence. When the reproduction signal sequence is subjected to PR (1,2,2,2,1) equalization, the fifth-bit code of each pattern is weighted with “2” in the equalization expected value of a code sequence subsequent to the detected pattern. In other words, this code is a code predominant in the equalization expected value of the code sequence subsequent to the detected pattern. Accordingly, the distance difference calculator 182 calculates the distance difference from the value yₖ₋₂ of the sample point of the reproduction signal sequence corresponding to this code.

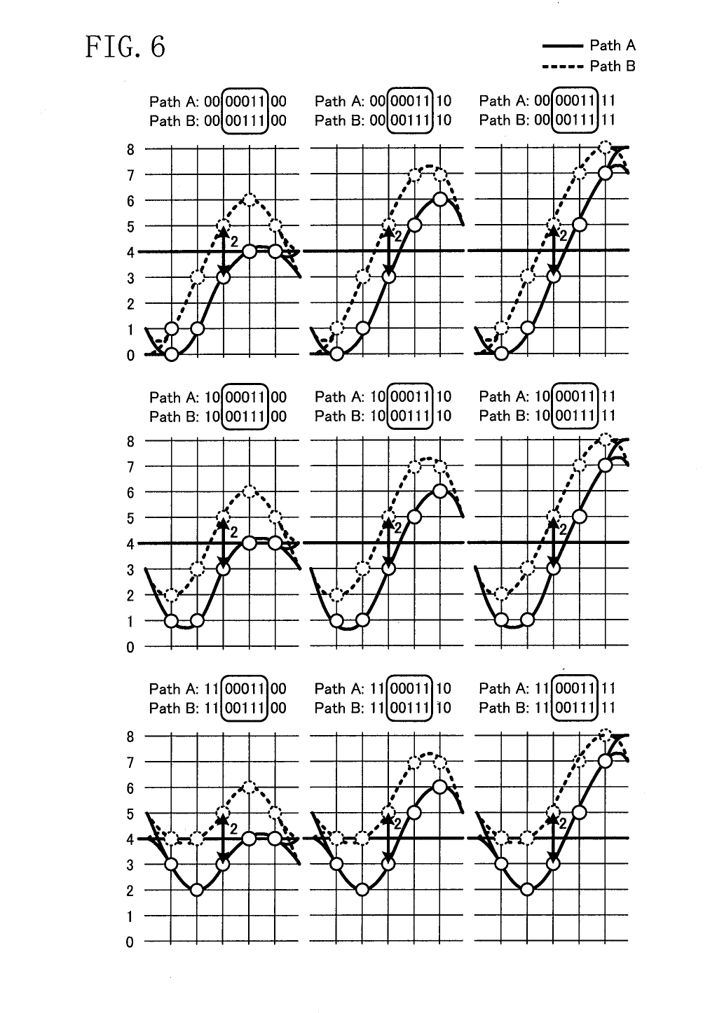

FIG. 6 shows views each having two paths (a path pair) corresponding to the pattern (00x11) among path pairs crossing the zero-cross level in PR (1,2,2,2,1) equalization. A total of nine path pairs are obtained when the pattern (00x11) is detected as shown in FIG. 6, and the equalization expected value for the sample point is “3” (path A) or “5” (path B) (Group I). Although not illustrated, the total number of path pairs obtained when the pattern (11x00) is detected is also nine, and the equalization expected value for the sample point is “3” (path A) or “5” (path B) (Group II). Any path pair belonging to these groups has a mutual distance dₘᵢₙ of 2.

Referring back to FIG. 5, the distance difference calculator 182 computes an expression corresponding to a pattern detected by the pattern detector 181 using the value of the sample point, to calculate the difference |Pa−Pb| between the distances between the reproduction signal sequence and each of the two paths. In this embodiment, in which the equalization expected value for the sample point is the same in Group I and Group II, when either of the patterns (00x11) and (11×00) is detected, the distance difference calculator 182 adopts, as the computation expression,

Cₖ₋₂−Eₖ₋₂

where Cⱼ=(yⱼ−3)² and Eⱼ=(yⱼ−5)².

As described above, in this embodiment, in the optical disc unit adopting PR (1,2,2,2,1) equalization, the quality of the signal reproduced from the optical disc can be evaluated with a calculation amount smaller than that conventionally required. A similar effect can also be obtained by generalizing the PR equalization into PR (a,b,c,b,a) equalization where a, b, and c are positive integers. By increasing the number of sample points to two or three, or by considering a virtual path as in the first embodiment, the precision of calculation of a dispersion in distance difference can be enhanced.

In the embodiments described above, the reproduction signal quality evaluation device 18 can be configured into a single semiconductor chip, or may be divided into a plurality of semiconductor chips. In the configuration of a single semiconductor chip, the chip may also include the adaptive filter 16 and the Viterbi circuit 17.

In the embodiments described above, as a known technique, the squaring in the calculation by the distance difference calculator 182 may be replaced with multiplication and addition (see Patent Document 1, for example). By this replacement, the circuit configuration of the distance difference calculator 182 can be simplified.

The reproduction signal quality evaluation device 18 of an embodiment of the present invention can be used in control for improving the reliability of the optical disc unit 100. For example, in FIG. 1, it is possible to determine the signal quality indicator from the standard deviation output from the dispersion calculator 183 while varying the frequency characteristic in the waveform equalizer 13, thereby to determine the frequency characteristic indicating the minimum value. In this way, the reliability of the optical disc unit 100 can be improved. As another example, the recording power and the recording compensation amount may be controlled so that the average value output from the dispersion calculator 183 is zero, or so that the signal quality indicator determined from the standard deviation output from the dispersion calculator 183 is minimum, thereby to optimize recording parameters for the combination of the optical disc unit 100 and the optical disc 101. In this way, the reliability of the optical disc unit 100 can be improved. The signal quality indicator can also be used in adjustment of servo control of the optical head 10, such as focus servo control, tracking servo control, disk tilt control, and lens spherical aberration correction control, for example.

What is claimed is:

1. A reproduction signal quality evaluation device configured to evaluate a quality of a reproduction signal from an optical disc, comprising:
a pattern detector configured to detect, from a code sequence obtained by PRML decoding, a predetermined pattern including a portion corresponding to a zero-cross point of a reproduction signal sequence obtained by PR equalization in PRML decoding;
a distance difference calculator configured to calculate a difference between distances between the reproduction signal sequence and each of two ideal transition sequences of the reproduction signal sequence by computing an expression corresponding to the detected pattern using a value of a sample point of the reproduction signal sequence that is in a portion corresponding to the detected pattern and corresponds to a code relatively greatly weighted in an equalization expected value of a code sequence subsequent to the detected pattern; and
a dispersion calculator configured to calculate a dispersion of the calculated distance difference.

2. The reproduction signal quality evaluation device of claim 1, wherein
the two ideal transition sequences are paths that can be selected in PRML decoding.

3. The reproduction signal quality evaluation device of claim 2, wherein
the PR equalization is PR (a,b,b,a) equalization where a and b are positive integers.

4. The reproduction signal quality evaluation device of claim 3, wherein
the distance difference calculator calculates the distance difference from values of one or two sample points each corresponding to a code weighted with the positive integer b.

5. The reproduction signal quality evaluation device of claim 2, wherein
the PR equalization is PR (a,b,c,b,a) equalization where a, b, and c are positive integers.

6. The reproduction signal quality evaluation device of claim 5, wherein
the distance difference calculator calculates the distance difference from a value of a sample point corresponding to a code weighted with the positive integer c.

7. The reproduction signal quality evaluation device of claim 1, wherein
the dispersion calculator calculates at least a standard deviation of the calculated distance difference.

8. The reproduction signal quality evaluation device of claim 7, wherein
the dispersion calculator calculates an average value of the calculated distance difference.

9. A reproduction signal quality evaluation method for evaluating a quality of a reproduction signal from an optical disc, comprising the steps of:
detecting, from a code sequence obtained by PRML decoding, a predetermined pattern including a portion corresponding to a zero-cross point of a reproduction signal sequence obtained by PR equalization in PRML decoding;
calculating a difference between distances between the reproduction signal sequence and each of two ideal transition sequences of the reproduction signal sequence by computing an expression corresponding to the detected pattern using a value of a sample point of the reproduction signal sequence that is in a portion corresponding to the detected pattern and corresponds to a code relatively greatly weighted in an equalization expected value of a code sequence subsequent to the detected pattern; and
calculating a dispersion of the calculated distance difference.

10. The reproduction signal quality evaluation method of claim 9, wherein
the two ideal transition sequences are paths that can be selected in PRML decoding.

11. The reproduction signal quality evaluation method of claim 10, wherein
the PR equalization is PR (a,b,b,a) equalization where a and b are positive integers.

12. The reproduction signal quality evaluation method of claim 11, wherein
in the step of calculating a difference, the distance difference is calculated from values of one or two sample points each corresponding to a code weighted with the positive integer b.

13. The reproduction signal quality evaluation method of claim 10, wherein
the PR equalization is PR (a,b,c,b,a) equalization where a, b, and c are positive integers.

14. The reproduction signal quality evaluation method of claim 13, wherein
in the step of calculating a difference, the distance difference is calculated from a value of a sample point corresponding to a code weighted with the positive integer c.

15. The reproduction signal quality evaluation method of claim 9, wherein
in the step of calculating dispersion, at least a standard deviation of the calculated distance difference is calculated.

16. The reproduction signal quality evaluation method of claim 15, wherein
in the step of calculating dispersion, an average value of the calculated distance difference is calculated.
